(19) United States
(12) Patent Application Publication
(10) Pub. No.: US 2024/0123570 A1
(43) Pub. Date: Apr. 18, 2024

(54) METHOD FOR GRINDING THE TOOTHING OR THE PROFILE OF A WORKPIECE

(71) Applicant: KAPP NILES GMBH & CO. KG, Coburg (DE)

(72) Inventor: Sergiy GRINKO, Coburg (DE)

(21) Appl. No.: 17/768,379

(22) PCT Filed: Oct. 9, 2020
(86) PCT No.: PCT/EP2020/078354

§ 371 Date: Apr. 12, 2022

(30) Foreign Application Priority Data
Oct. 17, 2019 (DE) 10 2019 128 100.8

(51) Int. Cl. B24B 49/04; B24B 19/00; B24B 49/10; B24B 49/12

(52) U.S. Cl. CPC B24B 49/04; B24B 19/009; B24B 49/10; B24B 49/12

(57) ABSTRACT

A method for grinding the toothing or the profile of a workpiece that has an axis of rotation and wherein an allowance is ground away from the surface of the tooth flanks of the toothing or the profile. The method includes the following steps: a) measuring the position of the surface of the tooth flanks of the toothing or the profile, wherein the measuring is carried out in at least two positions of the workpiece, which are arranged offset in the direction of the axis of rotation; b) determining the actually existing allowance of the workpiece that has not yet been ground, based on the measurement values from step a); c) determining at least one grinding parameter so that the material removal per time has a predetermined value or does not exceed a predefined value during grinding; and d) grinding the workpiece with the grinding parameters established in step c).

The invention relates to a method for grinding the toothing or the profile of a workpiece, in particular a gear wheel, wherein the workpiece has an axis of rotation and wherein an allowance is ground away from the surface of the tooth flanks of the toothing or the profile.

In a grinding process of the generic type, in particular in gear grinding, the workpieces are machined in series production in each stroke at a predetermined constant feed rate. In different strokes, however, the feed rates can differ (especially during rough machining and finish machining).

The machine parameters specified for the grinding process are based on predefined or specified values, whereby the allowance (per stroke) on the tooth flanks is of particular importance and determines how the machine parameters and, in particular, the feed rate are selected. The specified feed rate and the (radial) infeed between the workpiece and the tool for a given stock allowance result in the stock removal volume per time (i.e. the material removal rate), which is removed from the tooth flanks during the grinding process.

In practice, however, the actual allowance on the workpiece to be ground may differ from the specified allowance, both constantly over the entire width of the toothing and only locally over axial sections of the tooth flank.

To counter this problem, it is already known to design the grinding process adaptively and to use the power of the grinding motor or the current consumption of the grinding motor as the variable to be controlled. If the power consumption or the current increases, the feed rate is reduced accordingly.

Accordingly, the grinding machine is operated with a variable material removal rate over the grinding stroke. However, variable conditions are disadvantageous here from the point of view of tool wear and thermal tooth flank damage over the gear width.

A further disadvantage of this solution is that the process operated in this way is too imprecise and therefore does not always lead to a satisfactory grinding result.

The invention is based on the object of further developing a generic process in such a way that the grinding process is optimized. In particular, the relevant grinding parameters are to be adapted in such a way that a good grinding result and an economical process are obtained.

The solution of this problem by the invention provides that the method comprises the steps:
a) measuring the position of the surface of the tooth flanks of the toothing or the profile, wherein the measuring is carried out in at least two positions of the workpiece, which are arranged offset in the direction of the axis of rotation;
b) determining the actually existing allowance of the workpiece that has not yet been ground, based on the measurement values determined in step a);
c) determining at least one grinding parameter so that the material removal per time has a predetermined value or does not exceed a predefined value during grinding;
d) grinding the workpiece with the grinding parameters established according to step c).

The grinding parameter determined in accordance with step c) above is preferably the feed rate at which the grinding tool is moved during grinding of the toothing or profile. In this way, the material removal rate (material removal volume per time) can be kept constant as a function of the actual stock allowance (without changing the infeed and thus with a constant number of grinding strokes and, in turn, with favorable machining times per workpiece). In the machine control system, the feed per revolution is sometimes used as an input for this purpose, i.e. the feed rate as a function of the number of threads and the speed of the workpiece.

Alternatively, it is also generally possible that the defined grinding parameter is the infeed of the grinding tool relative to the workpiece. Both possibilities can also be combined.

According to one embodiment of the invention, the at least one grinding parameter can be determined on the basis of the maximum determined allowance of the workpiece. This value for the grinding parameter can then be kept constant for the grinding of the specific workpiece.

An advantageous alternative, however, is that the at least one grinding parameter is defined in the form of a course that changes in the direction of the axis of rotation and takes into account the respective locally existing allowance.

The measurement of the position of the surface of the tooth flanks of the toothing or profile according to step a) above can be carried out with at least two sensors, which are offset in the direction of the axis of rotation, but located at the same circumferential position of the workpiece.

Alternatively, it can be provided that the measurement of the position of the surface of the tooth flanks of the toothing or the profile according to step a) above is carried out with at least two sensors which are offset in the direction of the axis of rotation and arranged at different circumferential positions of the gear. This can prove to be very advantageous for reasons of the available installation space.

Another alternative option provides that the measurement of the position of the surface of the tooth flanks according to step a) above is carried out with a single sensor, which is arranged movably in the direction of the axis of rotation.

An optically acting sensor can be used as the sensor, whereby a laser can be used in particular. Inductive or capacitive sensors are equally suitable. Sensors that use eddy currents are also generally suitable.

A grinding worm is preferably used as the grinding tool. However, the use of a grinding wheel is also possible.

The workpiece to be machined is preferably a gear wheel with external teeth.

Thus, adaptive control, in particular of the feed rate during grinding, is realized so that the grinding process can always be kept within the optimum range. Fluctuations in the allowance can be effectively compensated.

The invention is thus based on the concept that the stock allowance is measured at at least two, and preferably at an even greater number of axial positions of the toothing or profile prior to the grinding process, and the feed rate for the subsequent grinding is then determined on the basis of the measurement.

The feed rate can be specified based on the maximum measured value of the stock allowance.

It is also possible, however, that a course for the feed rate is defined over the axial extension of the toothing and then used as a basis for the grinding process.

Accordingly, the workpiece is measured over the gear width or profile width before machining and an adjustment of the feed rate (constant or variable) is made on this basis.

Examples of embodiments of the invention are shown in the drawing.

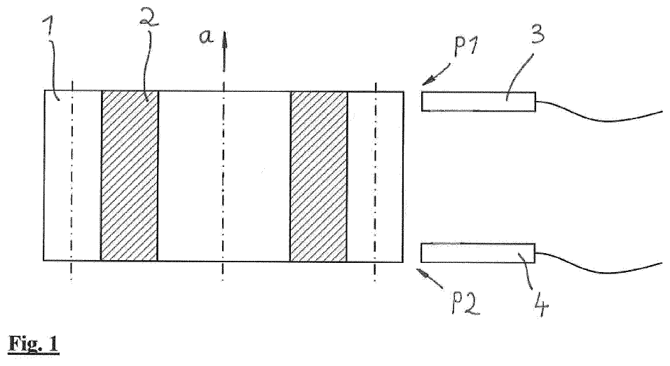

FIG. 1 shows schematically the measurement of the allowance of a gear according to a first embodiment of the invention,

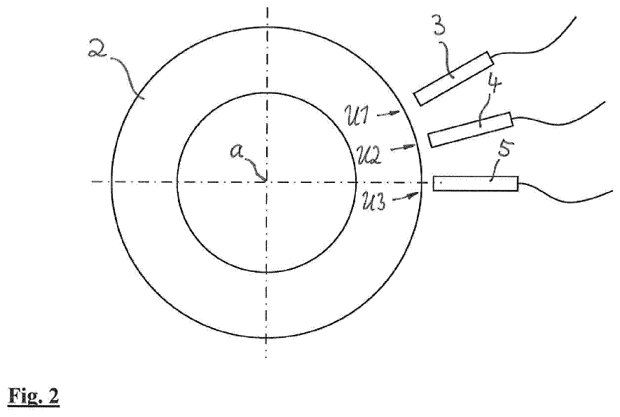

FIG. 2 shows schematically the measurement of the allowance of a gear according to a second embodiment of the invention,

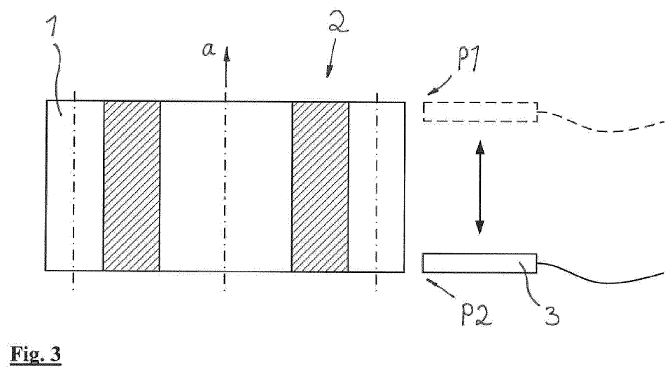

FIG. 3 shows a schematic representation of the measurement of the allowance of a gear according to a third embodiment of the invention,

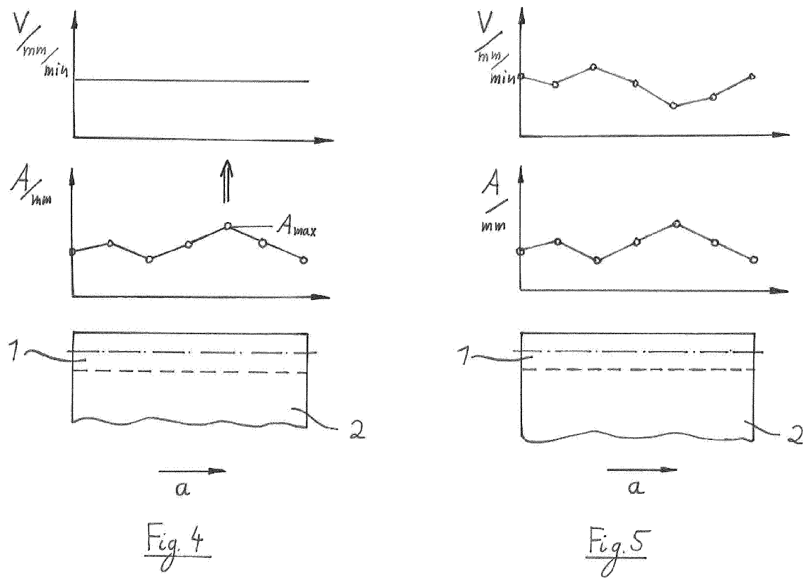

FIG. 4 shows schematically a gear for whose toothing the allowance A was determined over the axial extension (i.e. in the direction of the axis of rotation a), from which the course of a constant feed rate v during grinding was derived, and

FIG. 5 shows schematically a gear, for whose toothing the allowance A was again determined over the axial extension, from which the course of a variable feed rate v during grinding was derived.

FIG. 1 shows a gear wheel 2 with an axis of rotation a and a toothing 1 to be ground.

The gear wheel 2 has an allowance on the tooth flanks before its hard finishing, which is ground off by the grinding process to produce the finished part. The gear wheel 2 that has not yet been machined is often irregular with respect to the allowance, i.e. the allowance fluctuates within certain limits.

This follows from the fact that after hardening, the gear teeth are often distorted and thus exhibit unsystematic errors in the gear tooth profile, the gear tooth line and the gear tooth dimension. Furthermore, there may be wobble with respect to the clamping bore.

During grinding, this can lead to differences in terms of the material to be ground over the gear width and to corresponding differences in the tool load over the stroke.

Accordingly, the present invention provides for the adaptive setting in particular of the feed rate before the grinding stroke on the basis of the measured allowance, in accordance with the actual oversize.

For the nominal or theoretical allowance, data is initially available for the gear wheel in accordance with the design drawing, which leads to a corresponding sequence of grinding operations (number of grinding strokes, infeeds, etc.). However, these nominal values do not take into account the actual allowance on the tooth flank that is to be ground. Thus, the machining parameters (in particular feed rate or feed per revolution in each stroke) are first defined with a constant, nominal value.

However, if fluctuations in the allowance over the axial extent of the gear wheel (i.e. in the direction of the axis of rotation a) are detected by the measurement provided for in the invention, these findings are used to adjust in particular the feed rate or the feed per revolution.

Possible solutions for measuring the position of the surface of the tooth flanks, i.e. the actual allowance, of the gear wheel not yet ground are illustrated in FIGS. 1 to 3:

According to the invention, a measurement is made at at least two axially offset positions P1 and P2, as shown in FIG. 1. The two sensors 3 and 4 are located approximately in the two axial end regions of the toothing 1 and measure the effective allowance on the tooth flanks.

The signals from sensors 3 and 4 are picked up by the machine control (not shown), which can determine the actual stock allowance at the two measuring points P1 and P2 when the workpiece 2 rotates, taking into account the associated signals from sensors 3 and 4. Of course, more measuring points can also be provided in order to obtain more precise information regarding the actual stock allowance.

From the measured values of the position of the surface of the tooth flanks, the allowance can be easily determined as the difference between the actual dimension and the nominal shape of the tooth flank after the grinding process.

This means that information is now available on the distribution of the allowance over the toothing width (which can be done with sufficient accuracy by using an appropriate number of sensors).

It is therefore essential that the course of the allowance A is generally determined over the axial extent of the toothing 1.

FIG. 2 shows that the measurement is carried out with several sensors, here with the three sensors 3, 4 and 5, offset in the direction of the axis of rotation a and at the same time also offset in the circumferential direction. The three sensors 3, 4, 5 are arranged at different circumferential positions U1, U2 and U3. In this way, it is possible to accommodate all the required sensors in a space-saving manner, particularly where installation space is limited. This applies in particular in the case of a small tooth width.

FIG. 3 shows a variant in which a measurement can be made in several planes with only a single sensor 3. For this purpose, the sensor 3 is moved axially in the direction of the double arrow and the measured signals are recorded simultaneously. Thus, a spiral-shaped signal is then recorded here, which can be converted by the machine control into the effective allowance at the tooth flanks. Of course, it is also possible to carry out the measurement with the sensor stationary and then move it axially successively for measurement in several planes.

The sensors 3, 4, 5 can be located either separately or in a housing.

For all measurements, the machine control can determine from the (current) position of the sensor(s) and the rotational position of the toothing 1 where the surface of the measured tooth flank is located, so that the required information about the effectively available allowance can be obtained.

That is, if the relative positioning of the sensors to each other is known, it is possible to determine the allowance distribution of the toothing by converting the signals of the sensors accordingly, taking into account the geometry of the gear (in particular the helix angle in the case of helical toothing).

FIG. 4 illustrates the proposed process again:

The toothing 1 of the gear wheel 2 is measured by the sensors along the axial direction, i.e. in the direction of the axis of rotation a. In FIG. 4, the course of the allowance A determined in this way over the axial direction (direction a) is shown above the depicted gear wheel. In the embodiment shown in FIG. 4, the maximum value for the allowance Amax was determined from the recorded course of the allowance A. Based on this, the value of the allowance A was determined. Based on this, the value of the feed rate v for grinding was determined (this can be done by means of a correlation table stored in the machine control, in which a corresponding (optimum) value for the feed rate in mm/min is stored for a given value of the allowance in millimeters). The feed rate is specified here as a constant value over the entire tooth width.

Grinding at the feed rate determined in this way ensures high quality of the gear wheel 2.

FIG. 5 shows an alternative procedure. Again, the toothing of gear wheel 2 was measured and the allowance A was determined over the axial course (see diagram above the gear wheel shown in FIG. 5). In contrast to the procedure in FIG. 4, however, a corresponding value for the feed rate was determined for each determined value of the allowance at an axial position of the toothing 1 (again, for example, using the correlation table mentioned). This results in a variable course of the feed rate over the axial direction (direction a), as shown in the diagram in FIG. 5 above.

Grinding is now performed with the determined feed rate curve, thus ensuring constant grinding conditions across the width of the toothing.

The following should be noted with regard to the procedure shown and described in FIG. 5: Such a procedure can be relatively complex in terms of machine control. Therefore, as a variant to the procedure shown in FIG. 5, it is advantageous to smooth or approximate the determined course for the allowance or the course of the feed rate resulting therefrom. In this case, an “angular” course of the feed rate is avoided and instead an equivalent course of the feed rate is used over the axial direction a, which is smoothed and thus permits smoother operation. In this respect, it can also be considered as a further variant that the measured or determined values for the allowance or for the feed rate are adjusted by means of a compensation function.

By adapting the machining parameters, in particular the feed rate, to the current stock allowance situation during grinding, optimum grinding conditions can be ensured, resulting in high quality toothing with the best possible material properties.

### LIST OF REFERENCES

1 Toothing
2 Workpiece (gear wheel)
3 Sensor
4 Sensor
5 Sensor
a Axis of rotation of the workpiece
P1 First axial position
P2 Second axial position
U1 First circumferential position
U2 Second circumferential position
U3 Third circumferential position
A Allowance
Amax Maximal allowance
v Grinding parameter (feed rate v_{f})

1-10. (canceled)

11. A method for grinding the toothing or the profile of a workpiece, in particular a gear wheel, wherein the workpiece has an axis of rotation and wherein an allowance is ground away from the surface of the tooth flanks of the toothing or the profile, wherein the method comprises the following steps:
a) measuring the position of the surface of the tooth flanks of the toothing or the profile, wherein the measuring is carried out in at least two positions of the workpiece, which are arranged offset in the direction of the axis of rotation;
b) determining the actually existing allowance of the workpiece that has not yet been ground, based on the measurement values determined in step a);
c) determining at least one grinding parameter so that the material removal per time has a predetermined value or does not exceed a predefined value during grinding;
d) grinding the workpiece with the grinding parameters established according to step c),
wherein the defined grinding parameter according to step c) is the feed rate at which the grinding tool is moved when grinding the toothing or profile, wherein the determination of the feed rate takes place in the form of a course which changes in the direction of the axis of rotation and takes into account the respective locally existing allowance.

12. The method according to claim 11, wherein the measurement of the position of the surface of the tooth flanks of the toothing or of the profile according to step a) is carried out with at least two sensors which are offset in the direction of the axis of rotation but are arranged at the same circumferential position of the workpiece.

13. The method according to claim 11, wherein the measurement of the position of the surface of the tooth flanks of the toothing or of the profile according to step a) is carried out with at least two sensors which are offset in the direction of the axis of rotation and are arranged at different circumferential positions of the gear wheel.

14. The method according to claim 11, wherein the measurement of the position of the surface of the tooth flanks of the toothing or of the profile according to step a) is carried out with a single sensor which is arranged movably in the direction of the axis of rotation.

15. The method according to claim 12, wherein an optically acting sensor is used as the sensor.

16. The method according to claim 12, wherein an inductively or capacitively acting sensor is used as the sensor.
